(19) United States
(12) Patent Application Publication
(10) Pub. No.: US 2015/0350611 A1
(43) Pub. Date: Dec. 3, 2015

(54) METHODS AND SYSTEMS FOR MONITORING ENVIRONMENTS USING SMART DEVICES

(71) Applicants: Timothy R. PEARSON, Abingdon (GB); James L. WEST, Abingdon (GB); Michael D. FISCHER, Abingdon (GB); Michael J. EDGE, Abingdon (GB)

(72) Inventors: Timothy R. PEARSON, Abingdon (GB); James L. WEST, Abingdon (GB); Michael D. FISCHER, Abingdon (GB); Michael J. EDGE, Abingdon (GB)

(73) Assignee: Manything Systems Limited, Oxford (GB)

(21) Appl. No.: 14/292,276

(22) Filed: May 30, 2014

(51) Int. Cl. H04N 7/18; H04N 5/44; G06F 17/30; H04L 29/08

(52) U.S. Cl. CPC H04N 7/183; H04L 67/10; H04N 5/44; G06F 17/3028

(57) ABSTRACT

Methods and systems are provided for utilizing smart monitoring devices such as smart phones to provide video and environmental data monitoring services. Smart monitoring devices used in accordance with the systems and techniques described herein may monitor an environment continuously by capturing monitoring data such as still images, video, and/or environmental data and stream the monitoring data via the Internet and/or another network to a cloud storage provider. The cloud storage provider may provide users and/or others with the ability to view live or stored monitoring data, captured by a smart monitoring device, via the Internet and/or another network.

### CROSS REFERENCE TO RELATED APPLICATION

This application claims priority under 35 U.S.C. §119 to U.S. provisional patent application No. 61/828,943, filed on May 30, 2013, and entitled “Methods and Systems for Monitoring Environments Using Smart Devices,” which is incorporated herein by reference in its entirety.

### TECHNICAL FIELD

The present disclosure generally relates to audio and video recording and data management technologies and, in particular, to methods and systems for monitoring environments using smart devices.

### BACKGROUND

Video monitoring systems allow individuals and businesses to monitor premises for security, observation, and documentary purposes. As video recording and data storage technologies have improved, the demand has risen for more comprehensive monitoring coverage, and for smarter monitoring systems.

Conventional closed-circuit television (“CCTV”) systems utilize one or more video cameras to capture video to be monitored, typically for surveillance and/or security purposes. Conventional CCTV systems typically rely on external, rather than embedded, cameras, and are largely unsuitable for consumers and small businesses due to cost and complexity. CCTV is fixed point, immobile, requires wiring, is expensive, is complex to set up, and will not work during power loss. Like CCTV, web cameras are also generally wired devices that are substantially immobile. Although some web cameras are small and/or wireless, these devices usually sacrifice processing power and “smart” capabilities.

In recent years, smart phones have taken over the cellular telephone market. Many smart phones have significant processing power, multiple communication antennas, and small, portable form factors. Another area that has gained popularity is social video services that utilize smart devices to capture and produce videos, not for monitoring, but for sharing with people over the Internet. Conventional social video services are limited to point-and-shoot operations that require constant user control. Generally, these services are also limited to short-length videos, have limited settings for adjusting video parameters, and do not detect or capture environmental data such as movement.

### SUMMARY

Disclosed embodiments provide methods and systems for monitoring environments using smart devices.

Consistent with a disclosed embodiment, a video monitoring method comprises capturing, by a first monitoring device, monitoring data, the monitoring data including at least video data, analyzing the monitoring data in real time, by one or more processors in the first monitoring device, and wirelessly transmitting the monitoring data to a server in real time, thereby streaming the monitoring data.

Consistent with another disclosed embodiment, a monitoring device is disclosed, comprising a processor, a camera, and memory. The memory may have stored instructions which when executed causes the processor to capture monitoring data, the monitoring data including at least video data, analyze the monitoring data in real time, and wirelessly transmit the monitoring data to a server in real time, thereby streaming the monitoring data.

Consistent with other disclosed embodiments, non-transitory computer-readable storage media may store program instructions, which are executed by at least one processor device and perform any of the methods described herein.

The foregoing general description and the following detailed description are exemplary and explanatory only and are not restrictive of the claims.

### BRIEF DESCRIPTION OF THE DRAWINGS

FIG. 1 is a block diagram of an exemplary system consistent with disclosed embodiments.

FIG. 2 is a block diagram of an exemplary smart monitoring device consistent with disclosed embodiments.

FIG. 3 is a block diagram of an exemplary cloud service provider system consistent with disclosed embodiments.

FIG. 4A is a flowchart of an exemplary monitoring process.

FIG. 4B is a flowchart of an exemplary data transmission process.

FIG. 4C is a flowchart of an exemplary cooperative operation process.

FIGS. 5A-5C are illustrations of exemplary recording user interfaces.

FIG. 6 is an illustration of an exemplary settings user interface.

FIG. 7 is an illustration of an exemplary playback user interface.

FIG. 8A is an illustration of an exemplary live streaming interface.

FIG. 8B is an illustration of an exemplary animated live indicator animation.

FIG. 9 is an illustration of an exemplary clip creation user interface.

FIG. 10 is an illustration of an exemplary data management interface.

FIG. 11 is an illustration of an exemplary bookmark management interface.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments include methods, systems, and articles of manufacture such as non-transitory computer-readable media for utilizing smart monitoring devices (“SMD”) such as smart phones to provide high-end monitoring services that address needs not met by conventional systems, such as those systems described above. For example, an SMD used in accordance with the systems and techniques described herein may monitor an environment continuously by capturing monitoring data such as still images, video, and/or environmental data and stream the monitoring data via the Internet and/or another network to a cloud storage provider. The cloud storage provider may provide users and/or others with the ability to view live or stored monitoring data, captured by an SMD, via the Internet and/or another network.

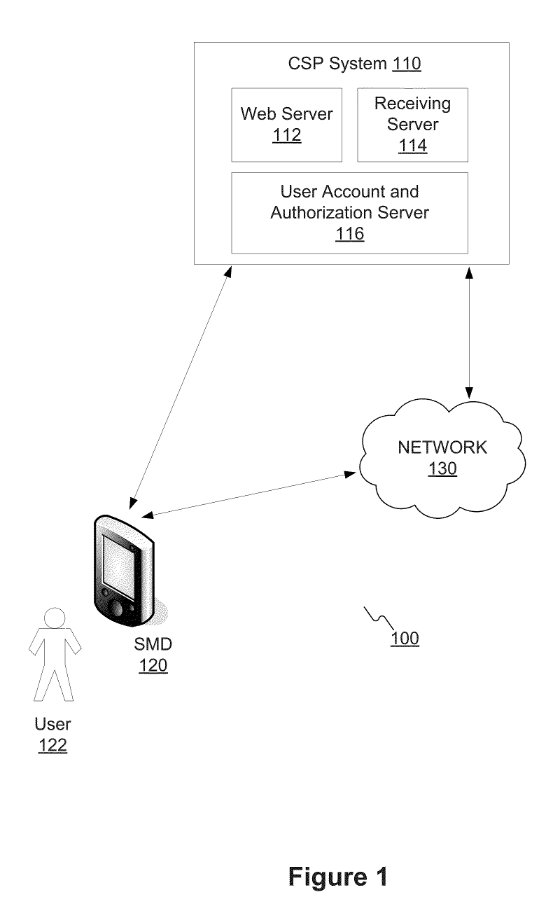

FIG. 1 is a block diagram of an exemplary system 100 for monitoring environments using smart devices. System 100 may include, for example, one or more SMDs 120 operated by one or more users 122, a cloud service provider system 110, and a network 130.

In some embodiments, SMD 120 is any smart device that includes at least a camera and adequate processing to send and receive data via network 130. SMD 120 may include, for example, a smartphone, tablet, digital camera, MP3 player, or other similar ubiquitous computing device.

A cloud service provider may be an entity that provides data processing services for user 122 using monitoring data received from SMD 120. The cloud service provider may operate cloud service provider system 110, which may include one or more servers including, for example, a web server 112, a receiving server 114, and a user account and authorization server 116.

System 100 components may communicate through network 130, which may be, include, or be part of any one or more of a variety of networks or other types of communication connections known to those skilled in the art. Network 130 may include a network connection, bus, or other type of data link, such as a hardwire or other connection known in the art. For example, network 130 may be, include, or be part of the Internet, an intranet network, a local area network, or other wireless or other hardwired connection or connections by which system 100 components may communicate.

SMDs 120 used in accordance with the systems and techniques described herein may be useful in numerous scenarios including, for example, security, pet monitoring, childcare, etc. As a specific example, SMD 120 may be used to capture and stream monitoring data related to newsworthy events. News organizations have traditionally had a high demand for still images of current events. Increasingly, such organizations are demanding video for their news reporting. To be valuable, however, still images and video must be received by such organizations almost instantly (e.g., ideally, seconds or minutes after the event). By utilizing the systems and techniques described herein, the needs of these organizations can be met. For instance, in some embodiments, one or more SMDs 120 continuously monitor an area, are location-aware, and are in continuous communication with a CSP system 110 that is connected either directly or indirectly to one or more news organizations and/or agents providing pictures and/or video to such organizations. Thus, as one example, a user operating CSP system 110 and monitoring a feed may recognize a newsworthy event and, via a control on the client application, send monitoring data from the CSP system 110 to the news organization or their agents. As another example, if a large number of SMDs 120 simultaneously show unusual activity in the same geographic area, a newsworthy event likely occurred in that area and monitoring data may therefore be transmitted to news organizations and/or their agents. As yet another example, if a newsworthy event is known to be taking place in a particular geographic area, then with agreement of SMD users 122, feeds from the users' SMDs 120 may be offered directly (or indirectly via CSP system 110) to news organizations and/or their agents.

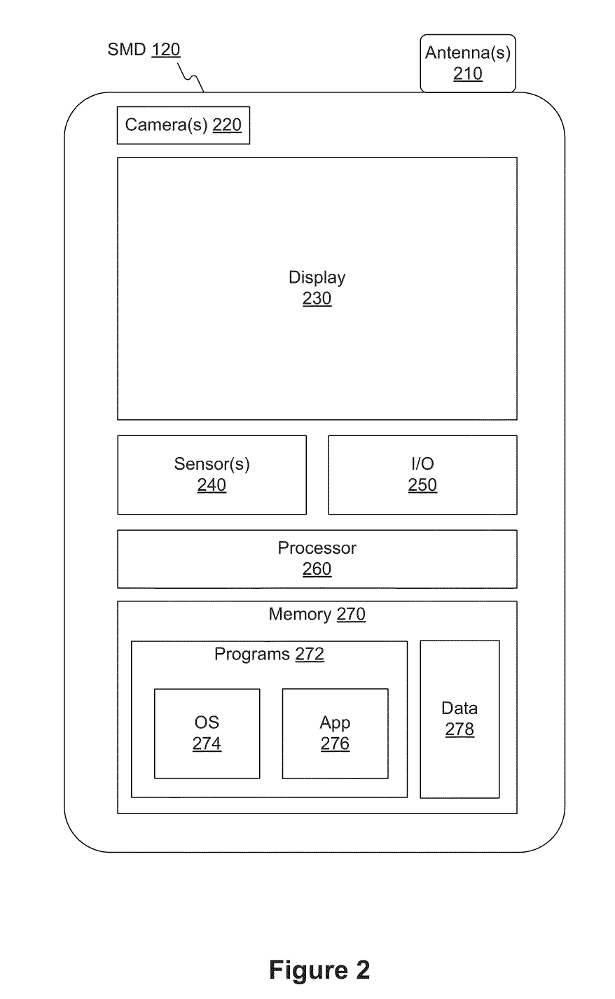

FIG. 2 is a block diagram of an exemplary SMD 120 for monitoring environments. In some embodiments, SMD 120 may be a commercially available mobile computing device, such as an Apple® iPhone®, iPod®, or iPad®, Android® smart phone or tablet, BlackBerry® smartphone, or Windows Phone® smart phone. In some embodiments, SMD 120 may include one or more antenna(s) 210, camera(s) 220, a display 230, sensors 240, input/output (I/O) device(s) 250, a processor 260, and a memory 270. In some embodiments, SMD 120 may also include one or more lights (not shown) for illuminating an area for recording video or capturing images.

In some embodiments, sensors 240 may include one or more of an accelerometer, gyroscope, compass, GPS, proximity sensor, light sensor, illuminator (e.g., IR and/or visible spectrum), thermal sensor, thermocouple, barometer, or ultrasonic sensor. In some embodiments, camera 220 and/or one or more of sensors 240 be embedded in SMD 120, and in other embodiments these components may be external and communicatively connected to SMD 120 by wired or wireless hardware.

Processor 260 may be, include, or be part of one or more known processing devices such as, for example, a microprocessor, a microcontroller, an application-specific integrated circuit (ASIC), a field programmable gate array (FPGA), or other type of processing circuitry, as well as portions or combinations of such circuitry elements.

Memory 270 may comprise electronic memories such as random access memory (RAM), read-only memory (ROM), or other types of memory, in any combination. One skilled in the art would be readily able to implement computer program code for storage in memory 270 to implement the functions described herein, given the teachings provided herein. Memory 270 may also be viewed as what is more generally referred to as a “computer program product” having executable computer instructions (program code) in accordance with discussed techniques embodied therein. Examples of computer program products embodying aspects of the invention may include non-transitory computer-readable storage media such as optical or magnetic disks, or other computer-readable media.

Memory 270 may store one or more programs 272 such as an operating system (OS) 274 and one or more applications (apps) 276. OS 274 may include commercially available operating system software such as iOS™, Android™, Windows Phone™, BlackBerry OS™, or any other operating system for mobile computing devices. Apps 276 may include one or more applications executable by processor 260 for use in accordance with the systems and techniques described herein. For example, app 276 may control the monitoring, encoding, analysis, and/or streaming of monitoring data to CSP system 110. Depending on the embodiment, app 276 may be, for example, pre-loaded on SMD 120, or downloaded and installed at a later time such as by user 122, and may be unique to each type of OS 274. In some embodiments, the systems and techniques described herein may be achieved at least in part by loading logic such as app 276 into memory 270 and executing the logic using processor 260.

In some embodiments, memory 270 may also store data 278, including monitoring data such as video data, still image data, and/or environmental data. Data 278 may be stored for later transmission if, for example, network 130 is unavailable or SMD 120 has insufficient battery power to connect to network 130. In some embodiments, data 278 may be stored as a backup copy of transmitted monitoring data.

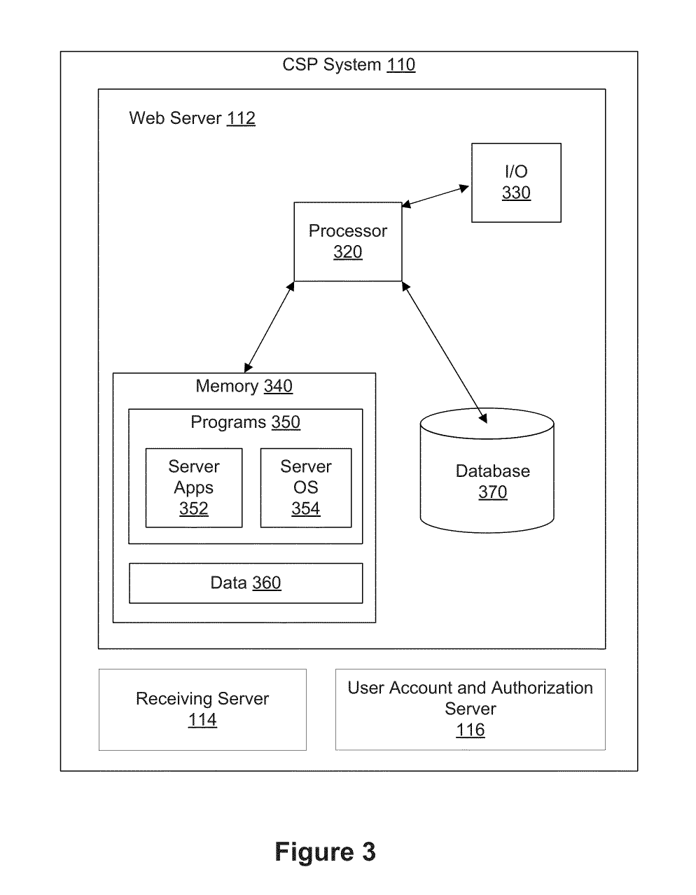

FIG. 3 is a block diagram of an exemplary cloud service provider (CSP) system 110. CSP system 110 may include one or more servers communicatively connected to one or more SMD 120 via network 130 including, for example, one or more receiving servers 114, one or more user account and authorization servers 116, and/or one or more web servers 112. Receiving server 114, user account and authorization server 116, and web server 112 may be, include, or be part of, for example, a general purpose computer, a server, a mainframe computer, a purpose-built computer, or a combination of one or more of the above.

Web server 112 may be, include, or be part of a technology and/or service that provides users access to monitoring data via the Internet or another network. In some embodiments, web server 112 may include one or more processors 320, input/output (I/O) devices 330, a memory 340, and one or more databases 370.

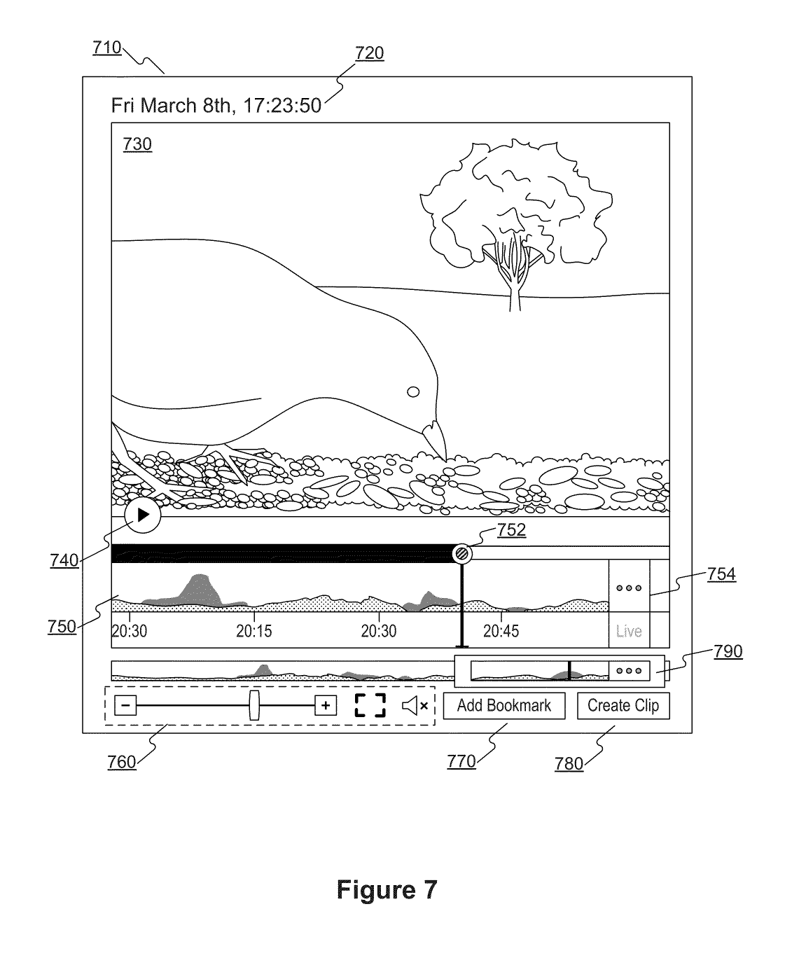

Web server 112 may be accessed by user 122 via one or more apps 276 such as a web browser or other application pre-installed or later installed on SMD 120, and app 276 may be unique to each SMD OS 274 platform. App 276 may deliver content to users in the form of HyperText Markup Language (HTML), Extensible Markup Language (XML), ADOBE FLASH, or any other type of data, or combination of data and formatting structure that may be used to deliver content to users. Content may include images, videos, text or other data, including monitoring data, that is suitable for the World Wide Web and can be displayed via a web browser or other application. In some embodiments, the client application may enable a user or others to view monitoring data ingested by a receiving server. For example, a user may view a live feed of, or stored, monitoring data, see events on a timeline graph (e.g., bookmarks) or in list form, bookmark specific points while viewing monitoring data, share monitoring data, zoom in or out on a timeline graph, capture thumbnails of video feeds, etc. Examples of these functions are discussed later with respect to FIGS. 7-11.

Although components of receiving server 114 and/or user account and authentication server 116 are not shown in FIG. 3, these servers may include similar components as those shown for web server 112. In some embodiments, web server 112, receiving server 114, and user account and authentication server 116 may be implemented as software programs executed on a single computer system, or in a distributed computing system using two or more systems having the components shown for web server 112. Furthermore, in some embodiments, CSP system 110 may include a single database 370 utilized by web server 112, receiving server 114, and/or user account and authentication server 116.

Receiving server 114 may be, include, or be part of a technology and/or service that receives, processes, and stores monitoring data from one or more SMDs 120. For example, receiving server 114 may receive a continuous stream of monitoring data including video data and environmental data while SMD 120 is in a live-streaming mode. Alternatively, receiving server 114 may receive periodic data transmissions from SMD 120 comprising video clips, still images, and/or environmental data that was previously recorded on SMD 120, and either selected by user 122 for transmission to CSP system 110 receiving server 114, or transmitted from SMD 120 upon reestablishing connection with network 130.

User account and authorization server 116 may be, include, or be part of a technology and/or service that identifies and authenticates a user of a service that utilizes the systems and techniques described herein. Identification and authentication may occur, for example, upon user 122 providing credentials unique to the user (e.g., username and password) or automatically based on such credentials upon reaching a system access point. Typically, authentication includes verifying the credentials provided by user 122 against credentials stored by the system and associated with the user 122. User account and authentication server 116 may receive credentials from SMD 120 or another computer terminal (not shown in figures) operated by user 122.

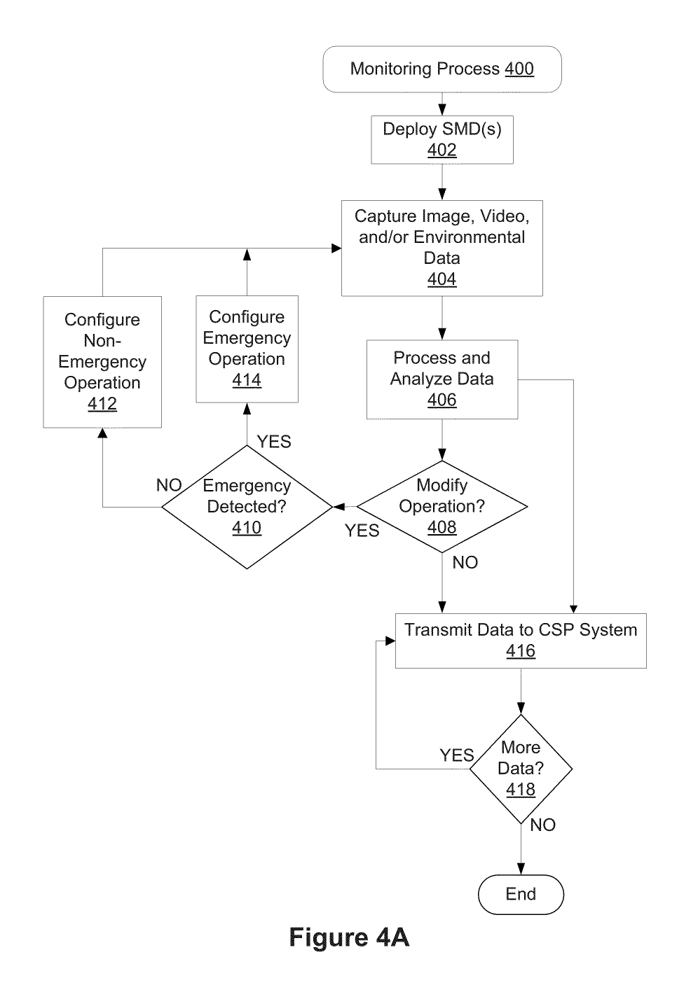

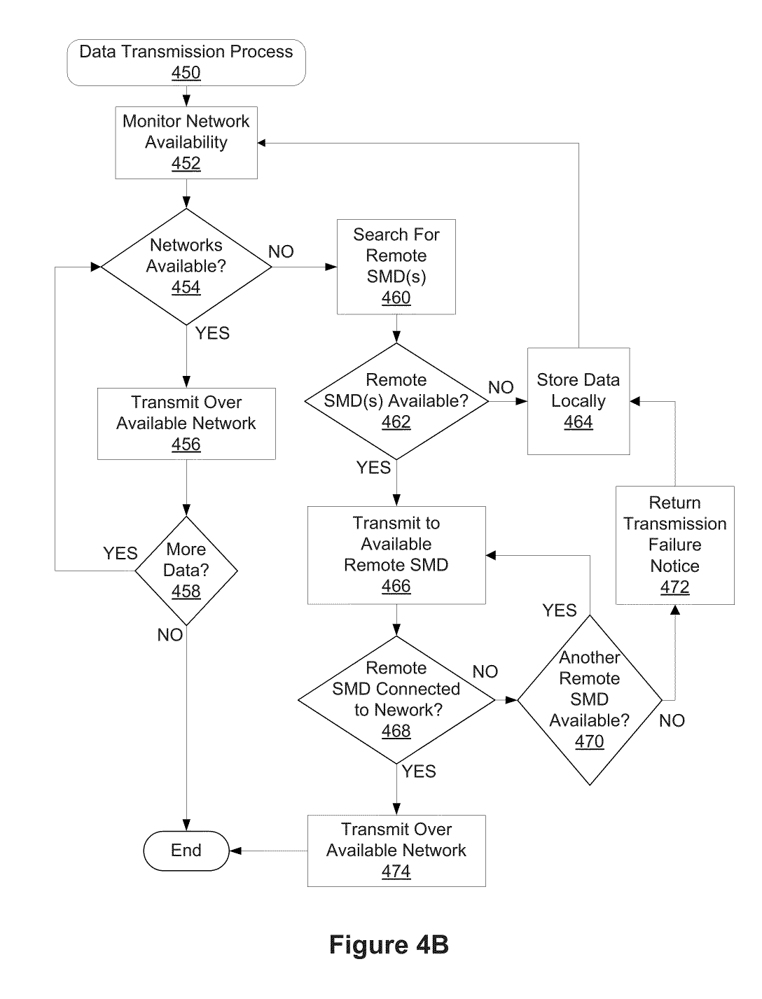

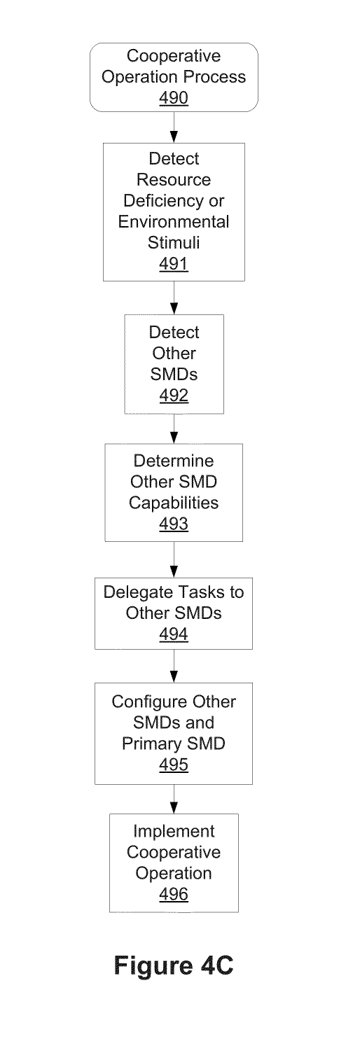

FIG. 4 is a flowchart of an exemplary monitoring process 400. In step 402, user 122 may deploy one or more SMDs 120 in one or more desired locations and, in some embodiments, configure one or more apps 276 such as monitoring software loaded on SMD 120 memory 270. In some embodiments app 276 may allow user 122 to configure various settings including, but not limited to, resolution, frame rate, alerts (e.g., email, SMS, etc.), fallback options, capture mode (e.g., video or still images), streaming options, connectivity options, and sharing options.

In step 404, deployed SMD 120s may capture still images and/or video using one or more cameras 220. One or more sensors 240 may also capture environmental data (e.g., sound, movement, etc.) simultaneously with the captured video and still images, to record aspects of the environment around SMD 120.

In step 406, SMD processor 260 may process the captured images, video, and/or environmental data. Unlike conventional monitoring systems, which generally place the time- and resource-intensive tasks of analyzing and processing monitoring data on central computing systems, the techniques and systems of some embodiments of the present disclosure may utilize the processing capabilities provided by SMD processor 260 to analyze and process monitoring data such as captured still images, video, and/or environmental data in near-real time as the monitoring data is recorded. Advantageously, SMD 120 may provide the monitoring data to cloud service provider receiving server 114 without burdening the CSP system 110 resources, permitting such resources to be available for other functions such as, for example, alerting features and playback of monitoring data. Similarly, in some embodiments, monitoring data may be optimized on SMD 120 prior to transmission to receiving server 114 to allow for low-cost processing at the CSP system 110. For example, in certain embodiments, the amount of motion in a captured video can be normalized with that in sequential still images such that a single measure of activity can be used across a long time frame.

In some cases, it is advantageous to split certain tasks between SMD 120 and servers of CSP system 110. For example, SMD 120 may be configured to monitor a defined grid, and monitoring data for each part of that grid may be sent to CSP system 110 for further analysis. However, depending upon the processing capability of servers of CSP system 110, performance may be compromised if such servers must process monitoring data received from many SMDs.

In some embodiments, in step 406 SMD 120 can also analyze monitoring data to detect specific events that can be bookmarked or cause a notification alert such as, for example, an email or SMS alert. For example, SMD 120 may be configured to detect a fire alarm, screaming or yelling, barking dogs, loss of main power, loss of Wi-Fi connectivity, and/or CO2 emissions. Using predetermined trigger values, processor 260 may generate one or more alerts to user 122 or others, and/or bookmark the trigger event. In a particular embodiment, such events may be detected based on, for example, noise intensity, frequency, pitch, repetitiveness, duration, etc., using sensor 240 such as a microphone. In some embodiments, such data from the microphone may also be used to take measurements during events such as, for example, precipitation amount, wind speed, rates of rotation, etc.

In some embodiments, in step 406 SMD 120 can also convert analog and digital displays into data logs. For example, an SMD 120 can recognize analogue inputs (e.g., dials, number drums, level markers, etc.) or digital displays (e.g., LCD screens, LED status lights, etc.) to establish, for example, scale and nature of what is being measured.

Referring still to step 406, in some embodiments motion can be detected by SMD 120 with minimal resource utilization by implementing specialized analysis to the video data encoded with conventional encoding techniques. For example, video is typically an encoded stream of p-frames (i.e., frames that indicate differences from prior frames), and less commonly, as i-frames (a complete picture). By taking the size of the p-frames, an approximate measure of the quantity of change from the previous frame can be extracted and used to detect movement.

In step 408, SMD 120 processor 260 may determine whether to modify SMD 120 operations based on available resources. As with any mobile device, SMD 120 operations may be affected by the availability and/or quality of required resources such as, for example, battery power, network connectivity, communication bandwidth, and processing power. For instance, an SMD 120 may have limited built-in processing power, or may have considerable resources already devoted to capturing and transmitting high quality monitoring data such that minimal resources remain, thereby limiting SMD 120's ability to perform other functions such as scene illumination, visual recognition, or monitoring data processing. Thus, some embodiments of the systems and techniques described herein provide adaptive techniques for accommodating such resource limitations by triggering changes in SMD 120 operation. Conversely, improvements in resource availability and quality may trigger SMD 120 operation changes. Those of ordinary skill in the art would appreciate that step 408 may be performed at any time during process 400, such as continuously, periodically according to a predetermined schedule, or upon detection of a predetermined event. In some embodiments, a predetermined event may require a certain amount or rate of change in resources to trigger an SMD 120 operation change. In certain embodiments, the amount a resource must change before triggering an SMD 120 operation change may depend on the particular resource.

In some embodiments, how SMD 120 responds to a change to the availability and/or quality of required resources or environmental stimuli is configurable and set by user 122. For example, user 122 may configure how SMD 120 responds if connectivity degrades, movement is detected in a region of the camera field of view, or sound of a certain pitch and duration is detected. This allows the user who requires continuous monitoring and transmission to keep costs and energy consumption down to a minimum unless a significant event is detected.

When SMD 120 decides to modify operation (“Yes” in step 408), SMD 120 then determines in step 410 if there is any emergency condition. If there is no emergency condition (“No” in step 410), then SMD 120 configures the non-emergency operation change in step 412.

As an example, in a particular embodiment, if communication with receiving server 114 degrades (e.g., bandwidth falls below a set threshold), in step 412 SMD 120 may enter a fallback mode, such as by capturing and streaming still images to receiving server 114 instead of video. Furthermore, if communication between SMD 120 and receiving server 114 is completely lost, SMD 120 may capture still images, and store the captured images on SMD 120 as data 278 in memory 260. Once SMD 120 reestablishes communication with receiving server 114, SMD 120 may transmit the stored still images.

As additional examples, a loss of main power or a reduction in battery life may trigger one or more non-emergency SMD 120 operation changes such as, for example:
Lowering the resolution of video capture;
Capturing and streaming still images instead of video (“still image mode”);
When in still image mode, reducing the frequency of still image captures;
When in still image mode, comparing captured still images to detect changes from one image to the next, and transmitting only images that indicate such changes, and sending, at most, only metadata when no change is detected;
Transmitting monitoring data at certain times based on user preferences, remaining battery life, and/or other triggers;
Transmitting monitoring data only during daylight based on sensed brightness levels, time of day, temperature, or other data;
Dimming scene illumination;
Dimming screen or other control interface illumination; and
Switching off non-essential services like location detection, proximity sensors, accelerometers, compasses, and radios not currently in use (e.g., WiFi, Bluetooth™, etc.).

As yet another example, if a primary communication channel, such as WiFi, is unavailable, in step 412 SMD 120 may switch communications to a secondary channel, such as a cellular communication channel. Furthermore, if a faster cellular communication channel is unavailable, SMD 120 may instead switch to the fastest available communication channel. For example, if SMD 120's connection to a 4G cellular network is interrupted, SMD 120 may automatically switch to a 3G communication channel to maintain continuous data transmission. As a resource's availability and/or quality returns to its optimal state, SMD 120 may again change its operation accordingly such as by resuming communication using the primary communication channel.

User 122 may select what types of communication channels to use as secondary channels, or may indicate that a secondary channel should not be used. For example, in some embodiments app 276 may request user input regarding whether to use 3G cellular communication when WiFi is unavailable, while warning user 122 that using 3G communication may exhaust user 122's data plan allotment.

In some embodiments, SMD 120 operation changes may also be triggered in response to environmental stimuli monitored using sensors 240 including embedded sensors and/or sensors connected via wired or wireless communication. SMD 120 may change operating modes to more efficiently capture, analyze, and stream monitoring data without having to continuously run all services and peripherals simultaneously. For example, in certain embodiments, embedded or external sensors and peripherals such as illuminators, may be triggered by sound picked up by a microphone, movement detected by a proximity sensor, and/or movement of the SMD detected by an accelerometer, GPS, or cellular network cell location change.

An advantage of the disclosed embodiments is that streaming video transmission can survive incoming phone calls or text messages. Conventional smart phones pause or end data transmission when a call or message is received. Using systems and methods of the disclosed embodiments, video transmission may be given priority over incoming transmissions, to maintain uninterrupted monitoring data streaming and provide an improved monitoring experience over current systems.

Referring again to step 410, in some embodiments, certain environmental stimuli detected by SMD 120 processor 260 analyzing sensor 240 data may trigger an emergency monitoring response 120 (“Yes” in step 410). For example, in certain embodiments, user 122 may mark one or more minimum and maximum numerical thresholds, and if the SMD 120 log indicates that a measured value is outside of the defined minimum and maximum threshold, then user 122 may be alerted (step not shown). Additionally, in some embodiments, such data exceeding the thresholds may be presented to the user in one or more ways such as, for example, as a tag on a timeline or graph, as part of a list, or by presenting the monitoring data itself.

Furthermore, in step 414 SMD 120 may configure an emergency operation, such as by causing other SMDs 120 in passive mode to become active. In some embodiments, the activated SMDs 120 may operate differently depending on the detected environmental stimuli. For instance, in some cases, the activated SMDs 120 may record for a period of time but not transmit monitoring data. As another example, when SMD 120 detects a large deceleration event or unanticipated change in location, in step 412 SMD 120 may configure an emergency operation such as entering a more active operation mode and start transmitting live and past monitoring data. As another example, the SMD may be caused to switch to a higher resolution mode in emergency situations in response to environmental stimuli.

After configuring a non-emergency operation modification (step 412) or an emergency operation modification (step 414), process 400 may return to step 404 to capture monitoring data (image, video, and/or environmental data) using the modified operation parameters. When conditions change again or return to normal (determined by repeating step 408), SMD 120 may again modify operation to return to default operating parameters or modified parameters determined based on the stimuli.

In step 416, SMD 120 transmits monitoring data to CSP system 110 using default operating parameters, or the emergency or non-emergency modified operating parameters. Under preferable conditions, step 416 occurs continuously as monitoring data is streamed in real time or near real time to CSP system 110. However, in some situations or in certain embodiments SMD 120 may transmit monitoring data periodically based on a predefined schedule or based on modified operating parameters as configured in step 412 or step 414.

In step 418, SMD 120 determines whether there is additional monitoring data for transmission, such as during live streaming. If all monitoring data has been transmitted (“No” in step 418), then process 400 ends.

FIG. 4B is a flowchart of an exemplary data transmission process 450 for transmitting data to network 130 via one or more remote SMDs. In some cases, even when communication with CSP system receiving server 114 is not available at the monitoring site, SMD 120 may be within range of other SMDs (referred to in this example as “remote SMDs”) that are capable of communicating with CSP system 110 via network 130. For example, a cave explorer with a SMD that is out of range of a communication network but within range of a safety team above ground with SMDs that are within range of a communication network may relay monitoring data via the safety team's SMDs. In this example, the caver's SMD relays its monitoring data to the cloud service provider using the safety team's SMDs as network repeaters. In these cases, some embodiments of the systems and techniques described herein enable the SMD 120 that is out of range of any communication network (such as network 130) to relay monitoring data via remote SMDs 120 within range of a communication network such as network 130.

As illustrated in FIG. 4B, to relay monitoring data, in step 452 SMD 120 monitors for network availability. If at least one network is available (“Yes” in step 454), such as network 130, SMD 120 transmits monitoring data over the available network in step 456. In step 458, SMD 120 determines whether there is more data to be transmitted, and if so, process 450 returns to step 454 to again determine whether any networks are available for transmitting the additional data. If there is no more data (“No” in step 458), then process 450 ends.

Returning to step 454, when it is determined that no networks are available (“No” in step 454), in step 460 SMD 120 may monitor or “search” for other remote SMDs within range using, for example, Bluetooth™. If no remote SMDs are available (“No” in step 462), then SMD 120 stores the monitoring data locally (step 464), and process 450 returns to step 452 to monitor network availability. When at least one remote SMD is available (“Yes” in step 462), then SMD 120 transmits the monitoring data using, for example, Bluetooth™, to the available remote SMD in step 466. If the remote SMD is connected to a network such as network 130 (“Yes” in step 468), then the monitoring data is transmitted over the available network to receiving server 114 (step 474), and process 450 ends. If the remote SMD is not connected to a network (“No” in step 468), then the remote SMD determines whether another remote SMD is nearby in step 470. If no additional remote SMD is nearby (“No” in step 470), then a notice is returned to the original SMD 120 indicating transmission failure in step 472, and the process returns to step 464.

When another remote SMD is available (“Yes” in step 470), the monitoring data is relayed to the next remote SMD (returning to step 466), and the receiving remote SMD then determines network availability (repeating step 468). Once a remote SMD that is connected to a network receives the monitoring data, the monitoring data is transmitted over the available network (step 474), thereby “daisy chaining” remote SMDs together using near communication means to relay monitoring data to its ultimate destination—receiving server 114.

In certain embodiments, monitoring data may be relayed using one or more communication means that are suitable for the monitored environment (e.g., sound, sonar, infrared, laser, etc.). It should be noted that in certain embodiments relaying monitoring data may involve multiple SMDs. For example, multiple SMDs within range of a network may all relay the same monitoring data. As described above and with respect to FIG. 4B, a chain of SMDs may be required to relay monitoring data to a CSP system 110.

In some embodiments, a change in the availability and/or quality of required resources or environmental stimuli may be addressed by the use of multiple, cooperative SMDs 120. In a particular embodiment, each SMD 120 may perform a different function to achieve a higher quality and more robust level of monitoring. For example, in a dimly lit environment with two available SMDs 120, instead of both SMDs 120 capturing high quality monitoring data, one SMD 120 may dedicate its operation to providing illumination while the other SMD 120 captures and streams monitoring data. As a result, the quality of the image may be improved.

To achieve cooperative SMD functionality, in some embodiments, each SMD 120 may be configured by default to operate in a specialized manner. In other embodiments, each SMD 120 may be enabled to operate in a cooperative and specialized manner based on specific needs and the capabilities of the SMD 120 on which recording is initiated (referred to for this example as the “primary SMD”).

FIG. 4C shows a flowchart of an exemplary cooperative operation process 490 involving multiple SMDs 120. Process 490 may begin in step 491 when a primary SMD detects a deficiency in required resources or one or more environmental stimuli. In step 492, the primary SMD may detect the presence of other SMDs. In some embodiments, the other SMDs may be queried by the primary SMD to determine whether they are capable of and are permitted to operate in a specialized manner (step 493), and if so, in which specialized modes the other SMDs can operate. In certain embodiments, the primary SMD may then determine how the other SMDs should operate based on, for example, SMD capabilities and/or environmental data. In step 494, the primary SMD can delegate tasks to the other SMDs based on their determined capabilities, specialization modes, and/or the environmental data. Specialization modes may include, for example, illumination, video capture, still image capture, location detection, audio capture, video analysis, audio analysis, and power management (e.g., option to plug one SMD into another and make its power available to the primary SMD). In some embodiments, specialization options and tasks for SMDs may instead or also be presented to a user for selection (step not shown). In step 495, the other SMDs may be configured to perform their delegated tasks, and the primary SMD may be configured to perform its tasks. Once the other SMDs are configured with their delegated tasks, the primary SMD and other SMDs may implement the cooperative operation in step 496.

Certain embodiments of the systems and techniques described herein may utilize external sensors and components to provide additional functionality (not shown in figures). For example, to improve monitoring in poorly lit conditions, radio-controlled lighting systems known to those in the art may be utilized. Such lighting systems may allow local and/or remote control of lighting. In some embodiments, SMD 120 may cause such lighting systems to turn on when sound or movement is detected as described herein. For example, SMD 120 may cause lighting systems to turn on when SMD 120 recognizes unusual sound or movement by either directly giving a command to switch on lighting or indirectly via a central server system and application programming interface (API). In another embodiment, user 122 can manually turn on such lighting systems. For example, user 122 viewing live monitoring data may instruct a central system to issue remote control to switch on the lights or alternatively instruct SMD 120 to switch on lights using its own local API.

Some embodiments may also combine SMD 120 with, for example, an external device such as a stand that provides both a low-cost passive infrared (PIR) sensor and a visible light source (e.g., LED, etc.). Combining the functions of SMD 120, a PIR sensor, and a visible light source provides a low-cost, moveable security installation. In these embodiments, the stand, which is connected to the SMD 120 via a wired connection such as a charger cable, may not only provide lighting, but also physically position the SMD 120's orientation and provide power. In another embodiment, the stand may provide additional data such as movement to SMD 120 based on, for example, PIR activation. In certain embodiments, SMD 120 may control the PIR and visible light source. For example, SMD 120 may indicate when to turn on the PIR and/or visible light source based on one or more conditions including, for example, movement or audio.

In some embodiments, SMD sensors 240 may include a magnetic switch such as a magnetometer. Magnetometers are standard on most current smart phones, but other forms of SMD 120 such as dedicated cameras may also include a magnetometer.

A magnetometer may advantageously provide mechanisms for controlling still image or video recording without the need for user 122 to control SMD 120 via a digital user interface or other peripherals that require power, network setup, and radio transceivers to communicate (WiFi, Bluetooth™, etc.). For example, an external device may be used in conjunction with the SMD 120 magnetometer to trigger still image captures, video recording, and/or environmental data monitoring.

The external device may include one or more magnets encased in a variety of external device housings such as key fobs, wall mounts, device docks, door and window frames, pet collars, flow rate counters, etc. The external device may include one or more components including one or more permanent magnets. In some embodiments, the external device may include a single magnet in applications where user holds the external device close to SMD 120 to trigger or stop monitoring.

In other embodiments, the external device may include multiple magnets in applications where a local electromagnetic pulse is required to register a trigger event from the effect of two magnets passing over one-another, such as a door or window being opened. This type of configuration may also be used in applications where SMD 120 is located in a temporary or permanent fixed position close to the external device.

In some embodiments, user 122 can customise the relationship between the magnetic external device and SMD 120, using, for example, app 276 to specify what action to take when electromagnetic pulses are detected by the magnetometer. In some embodiments, user 122 can specify the nature of the pulses (duration and frequency) required to trigger an action, or specify multiple pulse types and assign them to different actions.

To specify a pulse types and/or nature for triggering an action, app 276 may include a ‘learn mode.’ While in learn mode, SMD 120 can record an activity or sequence of activities performed by user 122. Once the sequence is recorded and identified as a trigger, app 276 can assign one or more actions to the trigger based on, for example, input from user 122. Some examples of triggers may include:
Holding an external magnet device near SMD 120 for a predetermined continuous period of time;
Moving an external magnet device near to and away from SMD 120 in a sequence of pulses; and
Sliding an external magnet device over an SMD 120 that has magnets embedded in the enclosure.

In some embodiments, app 276 may specify default settings and actions that user 122 may select or modify. Examples of actions may include:
Resetting SMD 120 settings;
Turning SMD 120 on or off;
Starting or stopping still image capture;
Starting or stopping video recording;
Starting or stopping environmental data detection; and
Starting or stopping alerting.

Depending on how the features and configuration of SMD 120, user 122 can receive audio, visual, and/or tactile feedback that the trigger has been received, such as by vibration, sound, illumination and/or message on display 230.

In some embodiments, SMD 120 actions can be triggered remotely using one or more remote SMD operating under the same user account. For example, an external device magnet may be placed in proximity to a remote SMD to cause the remote SMD to detect the trigger event. App 276 running on the remote SMD may transmit a notification based on the trigger signal to CSP system 110, which may then relay the notification to SMD 120, where SMD 120 processor 260 analyzes the notification and determines the appropriate action.

In some embodiments, SMD 120 can use app 276 to trigger third party devices via third party manufacturer APIs or other third party aggregator services like If This Then That (“IFTTT”). For example, when user 122 returns home and passes SMD 120 in close proximity over an external magnet device such as a wall plate, app 276 may automatically stop video recording, and send one or more commands via one or more APIs or IFTTT to turn on the heating/air conditioning and/or house lights.

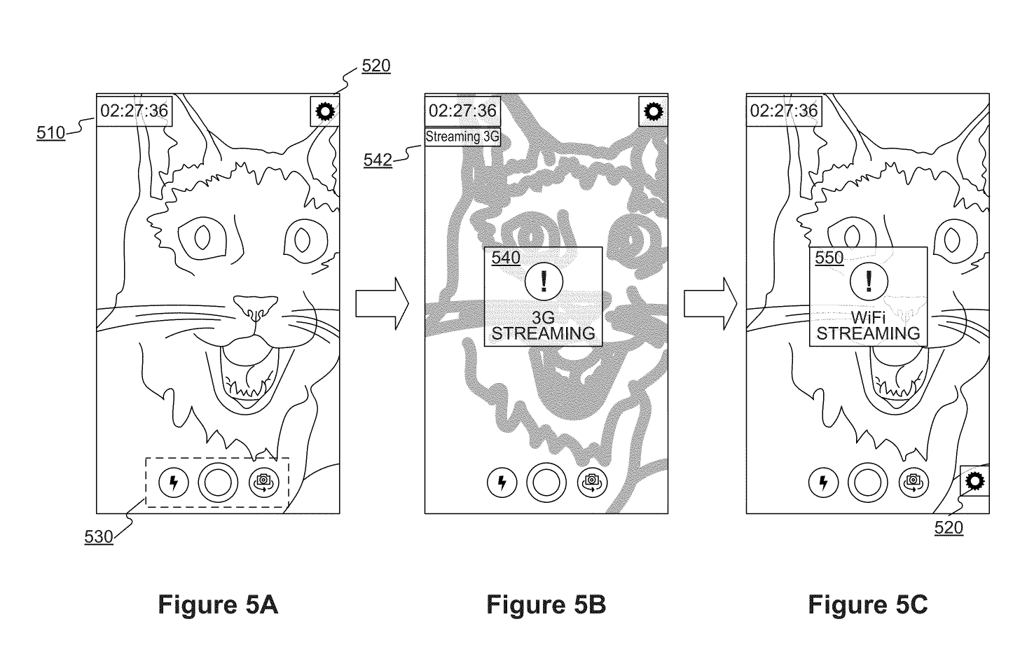

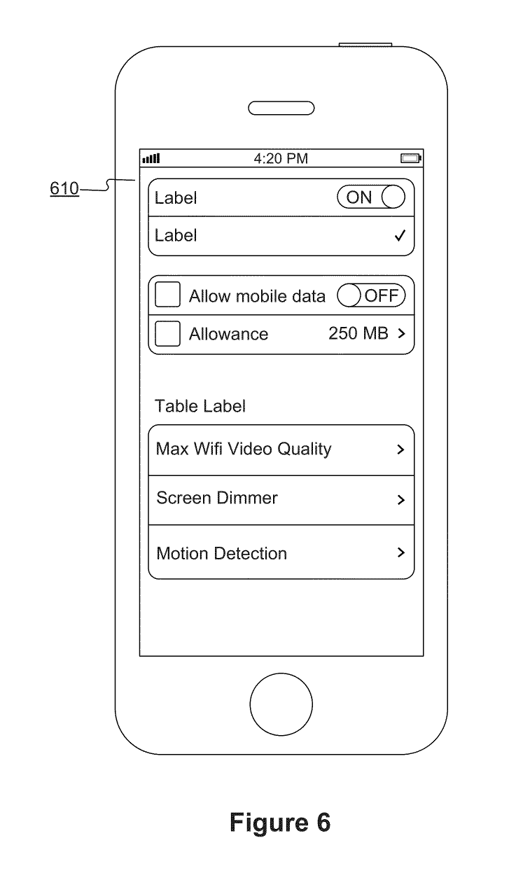

FIGS. 5A-C are illustrations of exemplary recording user interfaces. FIG. 5A shows an example of a recording interface under normal operating parameters. The interface may include a timer 510 showing the elapsed time for the recording, or the current time of day where SMD 120 is located. Settings button 520, when depressed or selected, may open one or more settings interfaces, such as settings interface 610 shown in FIG. 6.

Returning to FIG. 5A, operation buttons 530 may include, for example, a button for activating one or more lights on SMD 120 to illuminate the area, a button for starting and stopping monitoring data recording, and/or a button to toggle between different cameras when SMD 120 has more than one camera such as a front-facing and a rear-facing camera. Operation buttons may be “soft buttons” comprising icons displayed on SMD 120 display 230, and activated when SMD 120 detects touching or pressing on the location of display 230 at the location of one or more operation buttons 530.

FIG. 5B shows an example of a modified recording user interface for situations where SMD 120 switches communication channels due to a connection failure or insufficient bandwidth on the primary communication channel. In the example shown in FIG. 5B, SMD 120 switched data communication from WiFi to 3G cellular communication. Because 3G may offer slower data transfer speeds than WiFi, SMD 120 modified the resolution of recorded video (such as by changing one or more operation parameter in step 412 of FIG. 4B), resulting in lower-quality video but maintaining streaming video transmission. An alert box 540 may temporarily appear to alert user 122 that the communication channel has changed (in this case from WiFi to 3G), and a communication status icon 542 may be displayed on the interface while SMD 120 communicates over the secondary communication channel. In some embodiments, communication status icon 542 may appear at all times to indicate which communication channel SMD 120 is using. In other embodiments, communication status icon 542 may only appear while SMD 120 is using a communication channel other than the primary channel.

FIG. 5C shows an example of another recording user interface which may be displayed when SMD 120 reestablishes communication over the primary communication channel. In the example shown, SMD 120 has reestablished WiFi communication, and second alert box 550 may be temporarily displayed to inform user 122 of the change in operating parameters. SMD 120 may also increase the video resolution once communication over the primary channel is reestablished, as depicted by the sharper image in FIG. 5C, compared to FIG. 5B. Notably, the elements shown on the user interfaces in FIGS. 5A-5C may be rearranged automatically by SMD 120 or manually by user 122, as depicted by settings button 520 displayed in the lower right corner in FIG. 5C, compared to the top right corner in FIG. 5A. Those of ordinary skill in the art will appreciate that many different user interface layouts may be used depending on the needs of user 122 and app 276.

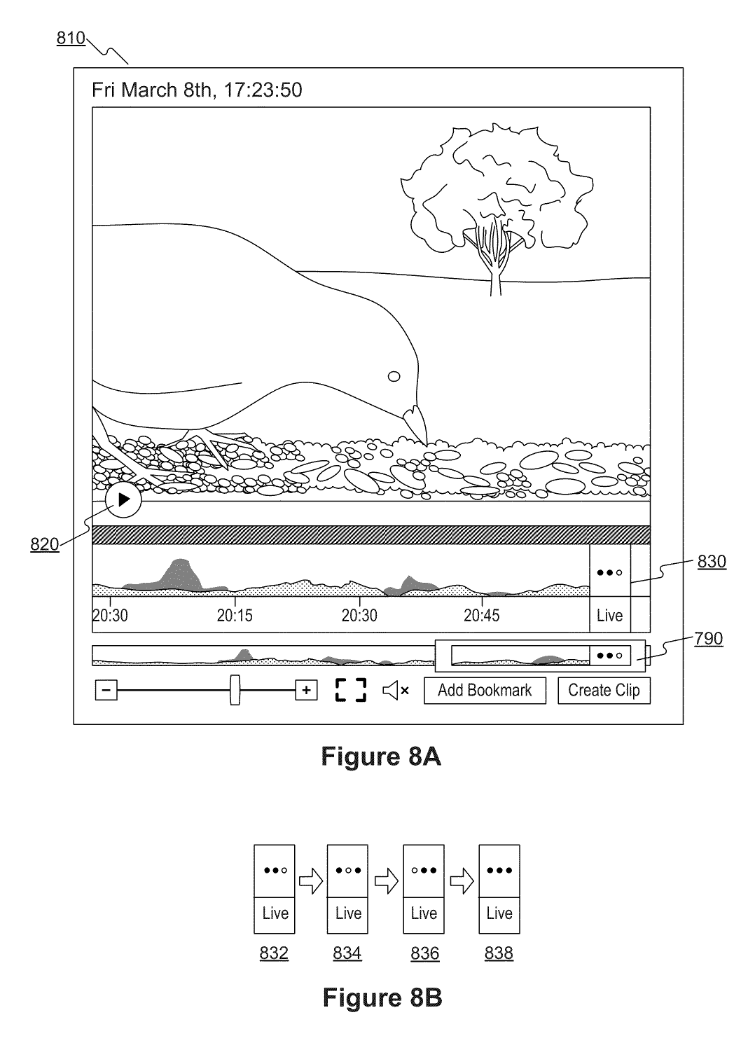

FIG. 6 is an illustration of an exemplary settings user interface consistent with disclosed embodiments. Settings interface 610 may appear upon user 122 selecting, for example, settings button 520 in the interfaces shown in FIGS. 5A-C. Settings interface 610 may include one or more settings pertaining to the monitoring data recording and transmission processes. User 122 may manually set labels for recordings, or choose not to use any labels. The use of mobile data (such as 3G and/or 4G cellular communication) may be toggled on or off depending on user 122's needs. Furthermore, settings interface 610 may allow user 122 to limit to the amount of mobile data expended on monitoring data transmission by changing the “allowance.” In some embodiments, settings interface 610 may allow user 122 to set maximum video qualities for one or more of the available communication channels, such as by setting the maximum video quality allowed for WiFi. Settings interface 610 may also allow user 122 to configure screen settings using the “Screen Dimmer” setting. For example, SMD display 230 may be configured to dim or turn off while recording is taking place, to conserve battery power in situations where user 122 is not watching SMD display 230 while recording. As an example, user 122 may desire to dim SMD display 230 when SMD 120 is set up as a fixed security camera for recording activity in a room. In some embodiments, settings interface 610 may also include settings for “Motion Detection,” to allow user 122 to configure SMD 120 to trigger recording when motion data is detected. For example, SMD 120 may be configured to begin recording when movement is detected in the field of view of camera 220, and/or when movement is detected by one or more sensor 240. A “Motion Detection” setting may also allow user 122 to activate and deactivate settings for recording and transmitting motion detection data associated with the captured video to receiving server 114, for displaying later during playback as discussed later with respect to FIGS. 7 and 8.

FIG. 7 is an illustration of an exemplary playback interface 710. Web server 112 may cause playback interface 710 to display on a device such as a computer terminal display (not shown in figures), or on SMD display 230 while viewing previous recordings stored at web server 112, Playback interface 710 may display the date and time 720 of the recording, a video box 730 with the video recording, a playback status indicator 740 indicating whether the video shown in video box 730 is playing, paused, or stopped.

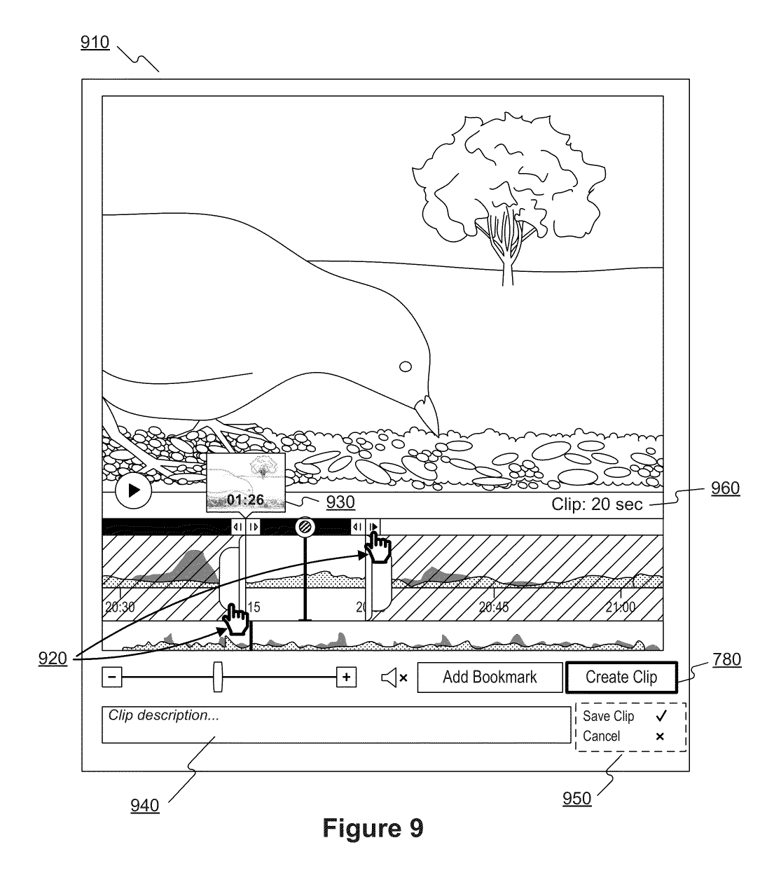

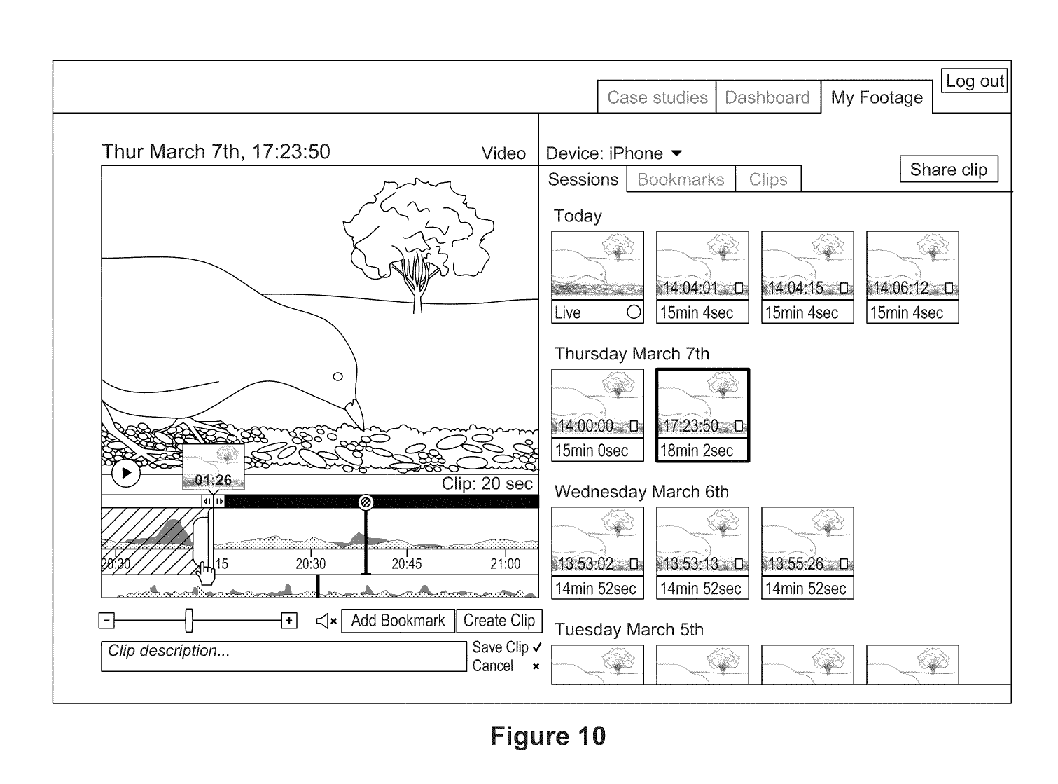

Playback interface 710 may include a timeline 750 to display a visualization of monitoring data against a horizontal axis representing the temporal position in the recording. In some embodiments, different types of monitoring data associated with the video may be displayed in different colors, such as audio data in a dark color, and movement data in a light, contrasting color. A play head 752 may indicate the position on timeline 750 corresponding to the image displayed in video box 730. A “live” indicator 754 may indicate whether the displayed video is live or a previous recording. As shown in the example in FIG. 7, the live indicator is greyed-out, signifying that the video is a recording, and not live. Playback setting controls 760 may allow user 122 (or a viewer other than user 122) to change the playback volume, toggle full-screen view, and/or mute the audio. Clip button 780 may cause 112 to display a user interface for creating a clip representing a portion of the recording, described later with respect to FIGS. 9 and 10. Slider 790 may display the monitoring data for the portion of the recording displayed in timeline 750. In situations where the recording is long, user 122 may use slider 790 to select an older portion of the recording for playback.

Another functionality that may be provided by the systems and techniques described herein is the ability to bookmark certain events in monitoring data as it is ingested, which may be particularly advantageous when handling large amounts of data. Bookmark button 770 may cause web server 112 to display a user interface for creating and storing a bookmark at the temporal position of play head 752. For example, user 122 may manually create one or more bookmarks, for example, by selecting bookmark button 770 or by performing an action such as shaking SMD 120.

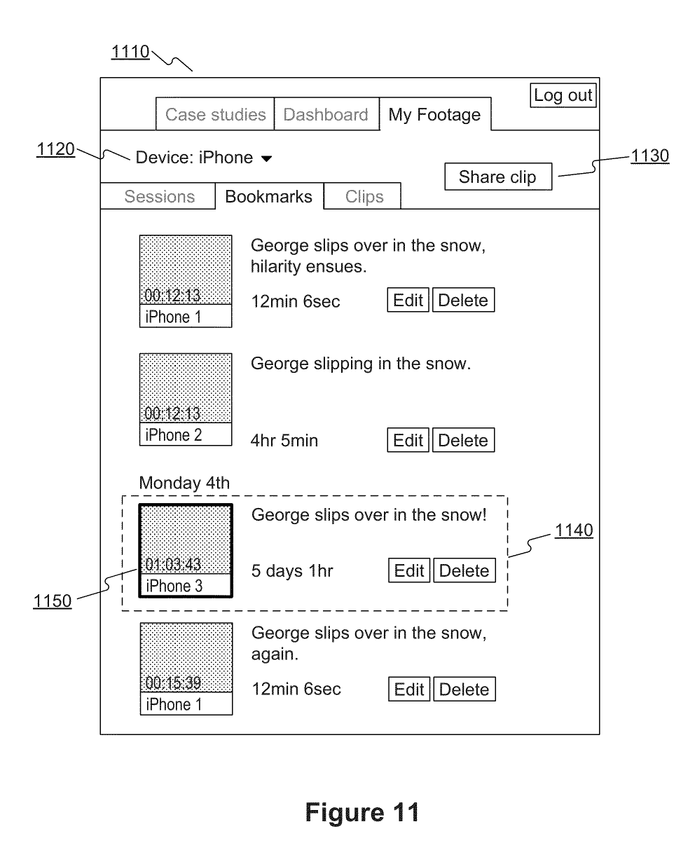

In some embodiments, systems and techniques described herein provide for audio, video, and other bookmarks that enable users to quickly find events of interest at a later time. In some embodiments, SMD 120 processor 206 may analyze monitoring data to automatically recognize certain events performed at the location of SMD 120, and attach metadata to the session clip while transmitting to CSP system 110 receiving server 114. For example, SMD 120 processor 260 may be configured to bookmark the occurrence of specific words using speech recognition techniques known to those in the art or noises above a certain decibel. As another example, SMD 120 may be configured to bookmark the occurrence of movement or certain colors. In some embodiments, such bookmarks may be presented to the user via a client application in one or more forms (e.g., part of a timeline, graph, list, etc.), as discussed in further detail with respect to FIG. 11.

FIG. 8A is an illustration of an exemplary live streaming interface 810 consistent with disclosed embodiments. Web server 112 may generate live streaming interface 810 for displaying a live streaming video feed from SMD 120. In some embodiments, live streaming interface 810 may appear similar to playback interface 710, with some differences. For example, the horizontal bar along which play head 752 moves in FIG. 7 may appear in FIG. 8 as a solid bar without any play head, because the displayed video is streaming. In some embodiments, live streaming interface 810 may also include an animated live indicator 830 to remind the viewer that the displayed video is a live feed. A small version of the animated live indicator may also appear in slider 790, such as the three dots shown in slider 790 of FIG. 8B. During live streaming, slider 790 remains fixed at the right portion of the live streaming interface 810. In some embodiments, user 122 or another viewer may drag slider 790 to the left to review previously recorded video and monitoring data, thereby exiting live streaming mode and entering playback mode, causing web server 112 to generate playback interface 710.

FIG. 8B is an illustration of an exemplary animated live indicator 830 animation. In the example, four frames of the animated live indicator 830 animation are shown, frame 832, frame 834, frame 836, and frame 838. In some embodiments frames 832-838 may appear in sequence to create the illusion of the white dot moving across the row of three black dots. Those of ordinary skill in the art will appreciate that other embodiments may incorporate different animations for animated live indicator 830.

FIG. 9 is an illustration of an exemplary clip creation interface 910, which web server 112 may generate upon selection of clip button 780. In some embodiments, clip creation interface 910 may include one or more controls for cropping a selected portion of video and/or monitoring data, controls for adding text to describe the clip, and controls to save or cancel the clip. For example, user 122 may slide one or more clip length controls 920 to define the beginning and ending of the desired clip within the entire recording. Clip preview box 930 may display the video frame at the position of the clip length control to assist user 122 in selecting the desired clip content. As shown in FIG. 9, portions of the monitoring data timeline outside the boundaries set by clip length controls 920 may be greyed out or shaded. In some embodiments, clip creation user interface 910 may provide a clip description box 940 for entering text describing the clip. Selection of save/cancel controls 950 may allow user 122 to save the video and/or monitoring data selection as a new clip, or alternatively cancel the clip creation and return to playback interface 710 or live streaming interface 810.

FIG. 10 is an illustration of an exemplary data management interface. In some embodiments, web server 112 may generate the session management interface alongside playback interface 710 or live streaming interface 810. The data management interface may display icons representing one or more recorded sessions, which may be organized by their capture date and time. The icons may include a thumbnail picture representing the video data, a timestamp indicating the time of day the session was recorded, and a time length of the clip. An ongoing live recording session may include a “Live” label. The data management interface may provide a scrollable list of session recordings for playback, clip creation, bookmarking, and/or sharing. For example, user 122 may select a session icon for display in the playback interface. Selected sessions or clips may be shared by selecting a “share clip” button, instructing web server 112 to send a selected session or clip to one or more social media services.

FIG. 11 is an illustration of an exemplary bookmark management interface 1110 consistent with disclosed embodiments. Web server 112 may generate bookmark management interface 1110 alongside playback interface 710 or live streaming interface 810, to display one or more bookmarks generated automatically by SMD 120 and manually generated by user 122. Bookmark management interface 1110 may list bookmarks in time-order. A device information portion 1120 may identify which SMD 120 recorded the monitoring data contained in the bookmarked clips or sessions. In some embodiments, a share clip button 1130 is provided to allow user 122 to send a bookmarked clip to one or more social network websites, or directly to other individuals via, for example, email. Each bookmark 1140 displayed on the bookmark management interface 1110 may include corresponding information such as, for example, an icon 1150 including a thumbnail image of corresponding video, a timestamp of the bookmark, and and an identification of the SMD 120 which generated the bookmark. Bookmarks such as bookmark 1140 may also include a description of the bookmark, entered by the bookmark's creator. In some embodiments, bookmark management interface 1110 may display “edit” and “delete” buttons next to each bookmark 1140, to allow user 122 to edit details of one or more bookmarks or delete one or more bookmarks.

The techniques described in this specification, along with the associated embodiments, are presented for purposes of illustration only. They are not exhaustive and do not limit the techniques to the precise form disclosed. Thus, those skilled in the art will appreciate from this specification that modifications and variations are possible in light of the teachings herein or may be acquired from practicing the techniques. For example, although aspects of the disclosed embodiments are described as being associated with data stored in memory and other tangible computer-readable storage media, one skilled in the art will appreciate that these aspects can also be stored on and executed from many types of non-transitory, tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A video monitoring method, comprising:
capturing, by a first monitoring device, monitoring data, the monitoring data including at least video data;
analyzing the monitoring data in real time, by one or more processors in the first monitoring device; and
wirelessly transmitting the monitoring data to a server in real time, thereby streaming the monitoring data.

2. The method of claim 1, wherein the monitoring device is a smartphone.

3. The method of claim 2, further comprising:
detecting, by the one or more processors, a change in one or more resources; and
modifying the capturing based on the detected change in resources, wherein the resources are at least one of battery power, communication network availability, or communication network bandwidth.

4. The method of claim 2, further comprising:
collecting, by the monitoring device, environmental data;
modifying the capturing based on the collected environmental data, wherein the environmental data corresponds to at least one of sound, movement, or location.

5. The method of claim 1, further comprising:
determining, by the one or more processors, that a network connection to the server is unavailable;
detecting, by the one or more processors, the presence of one or more second monitoring devices;
transmitting the monitoring data to the one or more second monitoring devices; and
instructing the one or more second monitoring devices to relay the monitoring data to the server.

6. The method of claim 3, wherein the modifying comprises:
detecting the presence of one or more second monitoring devices;
determining one or more capabilities of the one or more second monitoring devices; and
delegating one or more tasks to the one or more second monitoring devices based on the determined capabilities and the detected change in resources.

7. A non-transitory computer-readable medium having instructions stored thereon which when executed by one or more processors cause the one or more processors to perform the steps of:
capturing monitoring data by a first monitoring device, the monitoring data including at least video data;
analyzing the monitoring data by the first monitoring device; and
wirelessly transmitting the monitoring data to a server using the radio in real time, thereby streaming the monitoring data.

8. The non-transitory computer-readable medium of claim 7, further comprising:
detecting a change in one or more resources; and
modifying the capturing based on the detected change in resources, wherein the resources are at least one of battery power, communication network availability, or communication network bandwidth.

9. The non-transitory computer-readable medium of claim 7, further comprising:
collecting environmental data;
modifying the capturing based on the collected environmental data, wherein the environmental data corresponds to at least one of sound, movement, or location.

10. The non-transitory computer-readable medium of claim 7, the steps further comprising:
determining that a network connection to the server is unavailable;
detecting the presence of one or more second monitoring devices;
transmitting the monitoring data to the one or more second monitoring devices; and
instructing the one or more second monitoring devices to relay the monitoring data to the server.

11. The non-transitory computer readable medium of claim 7, wherein the modifying comprises:
detecting the presence of one or more second monitoring devices;
determining one or more capabilities of the one or more second monitoring devices; and
delegating one or more tasks to the one or more second monitoring devices based on the determined capabilities and the detected change in resources.

12. A monitoring device, comprising:
a processor;
a camera; and
memory having stored thereon instructions which when executed causes the processor to:
capture monitoring data, the monitoring data including at least video data;
analyze the monitoring data in real time; and
wirelessly transmit the monitoring data to a server in real time, thereby streaming the monitoring data.

13. The device of claim 12, wherein the device is a smartphone.

14. The device of claim 13, wherein the instructions further cause the processor to:
detect a change in one or more resources; and
modify the capturing based on the detected change in resources, wherein the resources are at least one of battery power, communication network availability, or communication network bandwidth.

15. The device of claim 13, further comprising:
an environmental sensor configured to collect environmental data,
wherein the instructions further cause the processor to modify the capturing based on the collected environmental data, wherein the environmental data corresponds to at least one of sound, movement, or location.

16. The device of claim 12, wherein the instructions further cause the processor to:
determine that a network connection to the server is unavailable;
detect the presence of one or more second monitoring device;
transmit the monitoring data to the second monitoring device; and
instruct the second monitoring device to relay the monitoring data to the server.

17. The device of claim 12, wherein the instructions further cause the processor to:
detect the presence of a second monitoring device;
determine a capability of the second monitoring device; and
delegate one or more tasks to the second monitoring device based on the determined capabilities and the detected change in resources.
